(19) United States
(12) Patent Application Publication
(10) Pub. No.: US 2004/0098448 A1
(43) Pub. Date: May 20, 2004

(54) Data distribution system

(76) Inventors: Hidehiro Fukushima, Fujisawa (JP); Shigeki Morimoto, Atsugi (JP)

Correspondence Address: Mattingly, Stanger & Malur, P.C., Suite 370, 1800 Diagonal Road, Alexandria, VA, 22314, US

(21) Appl. No.: 10/372,931

(22) Filed: Feb. 26, 2003

(30) Foreign Application Priority Data
Nov. 20, 2002 (JP) 2002-336061

(51) Int. Cl. G06F 15/16

(52) U.S. Cl. 709/201

(57) ABSTRACT

Disclosed is system for multicast distribution of stream data containing audio and video to a multicast network by way of a unicast network. System is comprised of a distribution device to distribute data sent from a transmit terminal to multiple receive terminals. The distribution device is comprised of information from the transmit terminal, a storage means for storing information linked to address information for distributing data to multiple receive terminals, a data distribution request-receive means to receive a request for data distribution from a receive terminal, and a data transmit-request means to search the linked information based on the data request-receive means and receive a request for transmission of data to the transmit terminal.

### BACKGROUND OF THE INVENTION

1. Field of the Invention

The present invention relates to a system capable multicast distribution by way of a unicast network when distributing stream data containing audio and video.

2. Description of Related Art

Multicast communication is known as a communication method for simultaneously sending the same data packet to multiple terminals. In multicast communication, the sender transmits a data packet addressed to a multicast group and a receiver who is a member of the multicast group can receive the data packet. The receiver can also stop receiving the data packets by leaving the multicast group.

The receiver terminal uses a group management protocol to send a control packet for executing a group join request for becoming a group member or a group leave request for quitting membership in the group to the multicast router connected on the same network. The group join request or group leave request can be sent at any time. An IGMP (Internet Group Management Protocol) in the standard advisory document RFC2236 drafted by the IETF (Internet Engineering Task Force) and MLD in the standard advisory document RFC2710 are utilized as the group management protocol.

The multicast router uses a group management protocol to send a join group query packet at periodic intervals to determine if a group member is present. A receive terminal that is a group member responds to that inquiry in the join group query packet. The multicast router determines that a group member is present if there is a response to the join group query packet, and forwards the data packet only for the network having the group member. The multicast router confirms that there is a group member and after deciding that the data packet must be forwarded, notifies other routers with a forwarding request, using a multicast routing protocol. When the multicast router decides that there is no group member and forwarding the data packet is unnecessary, it notifies other routers with a stop forwarding request. The multicast router rewrites (updates) its multicast forwarding information according to the contents of the reported multicast routing protocol. Typical multicast routing protocols are specified as PIM-SM (Protocol Independent Multicast-Sparse Mode) in RFC2362 and the MOSPF (Multicast Open Shortest Path First) in RFC1584. The PIM-DM (Protocol Independent Multicast-Dense Mode) and DVMRP (Distance Vector Multicast Routing Protocol) are examples of previously disclosed protocol drafts.

To operate a multicast distribution service, all routers that comprise the network must be capable of running (using) the multicast routing protocol. However when there are routers on the network that are incompatible with multicast, then tunneling technology must be utilized to set up a virtual forwarding path called a tunnel between the multicast routers. When the multicast router forming the start point of the tunnel must forward a data packet sent in multicast format, that data packet is encapsulated and sent as a unicast data packet towards the multicast router forming the end point of the tunnel. This encapsulated unicast packet data is forwarded as a normal unicast data packet by routers on the distribution path that are not compatible with multicast. The multicast router forming the tunnel end point extracts the multicast data packet from this encapsulated unicast packet data and forwards it onwards. An experimental network using this technology called Mbone (Multicast Backbone) has been established on the Internet.

One technology that does not use tunneling to distribute data on network systems having a mixture of networks compatible with multicast (hereafter called multicast networks) and networks incompatible with multicast has been disclosed. In this technology, a multicast communications device is connected to a network, and a sender and receivers connected to a network not compatible with multicast sends the multicast communication device to data transmit requests or a data receive requests. After making the data transmit request, the data sender sends data in unicast to that multicast communications device. This multicast communications device of the disclosed technology changes the data received in unicast to multicast (data) and distributes it within the multicast network.

[Patent Document 1]

JP-A No. 185528/2002

In order to distribute data by multicast on the Internet or a corporate network using multicast, all routers and terminals on the network must have the multicast function. The number of terminals compatible with multicast is currently increasing and there are a certain number of Internet service providers that distribute services by multicast. However there are still many routers that are not compatible with multicast and making all devices multicast compatible would be very expensive. So even if the receiver terminal is connected to the multicast network, unicast must be used when distributing data to large numbers of terminals from a sender terminal connected to a network that is not multicast compatible which creates a large traffic flow on the network.

In the invention disclosed in JP-A No. 185528-2002, the sender can transmit data in unicast format to a multicast communication device. However, in order to transmit data as directed by the sender, the data must be sent to multicast communication devices even when there is no receiver, creating unnecessary network traffic between the sender terminal and multicast communication devices and applying an extra load on the multicast communication devices.

### SUMMARY OF THE INVENTION

It is therefore an object of the present invention to provide a system allowing multicast distribution of stream data from sender terminals not connected to a multicast network, to terminals connected to a multicast network to suppress the amount of traffic flowing through the entire network.

To achieve the above described objects of the present invention, a multicast communication device installed between a multicast network and networks not compatible with multicast, is capable of receiving a request for multicast distribution of stream data from a terminal connected to a multicast network; accessing the sender terminal not connected to a multicast compatible network (hereafter Distribution server) holding the stream data; receiving the stream data in unicast format from the distributor server; and then distributing the received stream data by multicast to terminals connected to a multicast network.

The multicast distribution device contains a data management table for linking the multicast group address which is the distribution address for the stream data, with stream data information available for multicast distribution. This management table can be set by the administrator of the multicast distribution device and information for example on the distribution server (IP address and URL) holding the stream data can be stored here. The user can also be informed of this management table to allow informing the user about receivable stream data information. When the user selects stream data on the receive terminal, a group join request is sent from the receive terminal to the multicast group address that distributes the stream data. When the nearest multicast router receives this group join request, it sends a data distribution request to the sender terminal using a multicast routing protocol. In the related art, the distribution request is sent by the multicast routing protocol from the sender terminal to each receiver terminal by the multicast routers on the shortest path and arrives at the multicast router closest to the sender terminal.

The distribution request can be received by operating the multicast distribution device as a multicast router. When a distribution request for the multicast group stored in the management table is received, the multicast distribution device accesses the distribution server holding stream data for that corresponding multicast group, and requests distribution of the specified desired stream data. When the stream data packet from the distribution server arrives as unicast (data) at the multicast distribution device, the multicast distribution device converts the received unicast data packet into a multicast data packet and forwards it into a multicast network so that each receiver terminal receives the desired specified stream data in multicast. When a distribution request has arrived for the same stream data from a terminal connected to the multicast network, the multicast distribution device has already forwarded the data in multicast format so the nearest multicast router makes a multicast transmission to each receiver terminal.

When finished receiving the data, the receive terminals send a group leave request from the multicast group currently receiving data. When the nearest router receives the group leave request, a data forwarding stop request is sent to the sender terminal, the same as when a group join request is made. The multicast router receives this data forwarding stop request and again sends the data forwarding stop request to the sender terminal when it decides there is no need for itself to forward the multicast data by multicast routing protocol processing. The multicast distribution device receives this data forwarding stop request, and stops the receiving of data from the distribution server when it decides there is no receive terminal for the stream data.

The present invention is therefore capable of acquiring data by unicast transmission from a sender terminal when a data distribution request was made from a terminal connected to a network capable of multicast distribution, for data held by a terminal connected to a network not capable of multicast distribution. By then distributing the data by multicast transmission to a network capable of multicast distribution, the amount of traffic flowing through the entire network can be reduced.

### BRIEF DESCRIPTION OF THE DRAWINGS

FIG. 1 is a drawing of the structure of the multicast distribution system of the first embodiment of the present invention;

FIG. 2 is a block diagram of the multicast distribution device 10;

FIG. 3 is a diagram of the packet 30 for processing by the multicast distribution device 10;

FIG. 4 is a drawing showing an example of the data management table 17 contained in the multicast distribution device 10;

FIG. 5 is a drawing showing an example of the multicast translation table 16;

FIG. 6 is a diagram of the processing sequence for the terminal to receive the data packet from the distribution server;

FIG. 7 is a diagram of the processing sequence when the terminal quits the group;

FIG. 8 is a flowchart of the packet processing sequence of the multicast distribution system 10;

FIG. 9 is a flowchart of the data transfer process;

FIG. 10 is a flowchart of the multicast protocol processing;

FIG. 11 is a flowchart of the access control processing;

FIG. 12 is a diagram of the processing sequence for the terminal to receive the data packet from the distribution server in the second embodiment;

FIG. 13 is a drawing of the structure of the multicast distribution system of the third embodiment;

FIG. 14 is a block diagram of the multicast distribution device 90 of the third embodiment;

FIG. 15 is a flowchart of the packet receive processing of the multicast distribution device 90;

FIG. 16 is a flowchart of the data transfer process;

FIG. 17 is a flowchart of the multicast routing processing;

FIG. 18 is a drawing of the structure of the multicast distribution system of the fourth embodiment;

FIG. 19 is a block diagram of the multicast distribution device 100;

FIG. 20 is a block diagram of the data management device 120;

FIG. 21 is a diagram of the processing sequence for the terminal to receive the data packet from the distribution server in the fourth embodiment;

FIG. 22 is a flowchart of the packet receive processing of the multicast distribution device 100;

FIG. 23 is a flowchart of the multicast routing processing;

FIG. 24 is a flowchart of the translation information update processing;

FIG. 25 is a flowchart of the packet receive processing of the data management device 120;

FIG. 26 is a flowchart of the access control processing; and

FIG. 27 is drawing of the structure of the multicast distribution system of the fifth embodiment.

### DETAILED DESCRIPTION OF THE PREFERRED EMBODIMENTS

The embodiments of the present invention are described next while referring to the accompanying drawings.

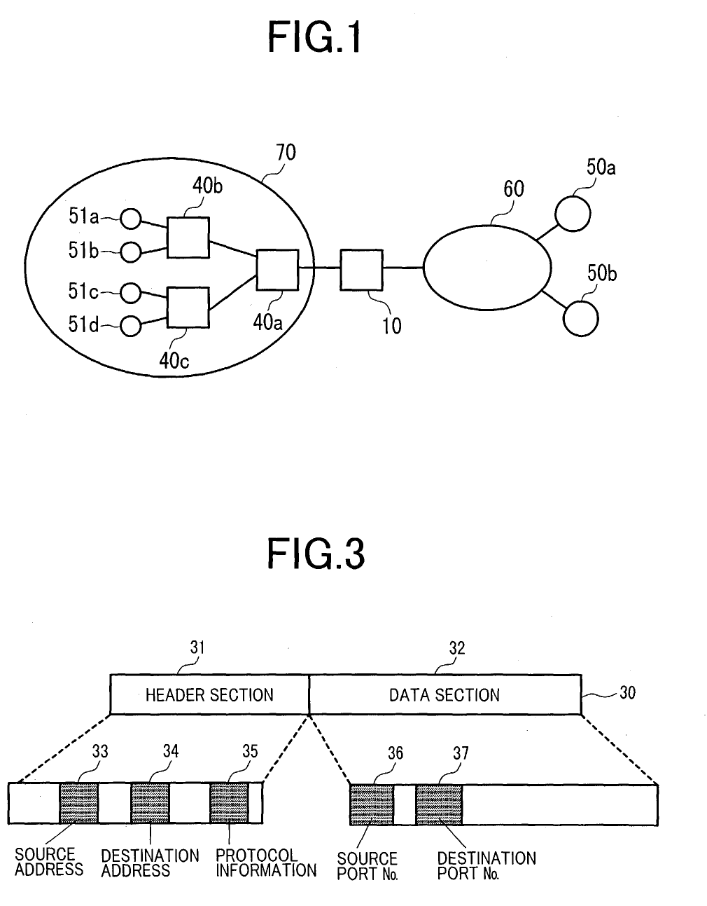

FIG. 1 is a drawing showing a concept view of the structure of the multicast distribution system of the first embodiment of the present invention.

In this multicast system, a multicast network 70 capable of communication by multicast and a unicast network 60 not compatible with multicast are connected by a multicast distribution device 10.

The multicast distribution device 10 has an address M1 for the unicast network 60 and an address M2 for the multicast network 70 and is connected respectively to both of these networks. A distribution server 50a (host name is svr1, address is S1), and a distribution server 50b (host name is svr2, address is S2) are connected to the unicast network 60. The multicast routers 40a, 40b, and 40c are installed within the multicast network 70. The multicast routers 40b and 40c are installed subordinate to the multicast router 40a. The terminals 51a, 51b are connected to the multicast router 40b. The terminals 51c, 51d are connected to the multicast router 40c.

The multicast distribution device 10 is connected to the multicast router 40a. This multicast distribution device 10 conveys the distribution program within the multicast network 70 as a multicast transmission according to its internal data management table.

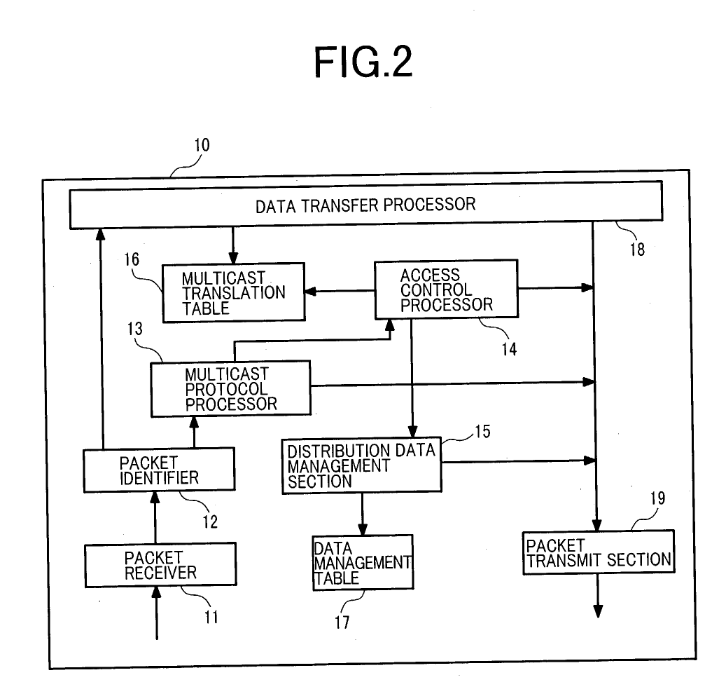

FIG. 2 shows a block diagram of the multicast distribution device 10.

A packet receiver 11 receives the stream data packet sent from the distribution server and control packets relating to the multicast routing from the nearest multicast router and sends them to the packet identifier 12. The packet identifier 12 identifies whether the received packet is a data packet. The packet is sent to the multicast protocol processor 13 if a control packet. The packet is sent to the data transfer processor 18 if a data packet.

The multicast protocol processor 13 extracts the group address information from the control packet and sends the extracted group address information and the control packet contents to the access control processor 14. The multicast protocol processor 13 also has a function to periodically send the control packet for multicast routing protocol. By sending this control packet, the same operation as the multicast router can be simulated when the multicast distribution device 10 was searched from the multicast router so that a multicast control packet can be received from the nearest multicast router.

The access control processor 14 checks whether the group address information reported from the multicast protocol processor 13 is stored in the multicast translation table 16. If the group address information is not stored (registered) in the multicast translation table 16, an inquiry is made to the distribution data management section and information acquired from the distribution server holding stream data information corresponding to that group address. The terminal (or client) usually utilizes a dedicated protocol to request data distribution in order to receive data such as stream data from the server.

These dedicated protocols may be “HTTP” (Hyper Text Transport Protocol) specified in RFC2817 or “RTSP” (Real Time Stream Protocol) specified in RFC2326, etc. For example, to access by utilizing HTTP, a session is first established utilizing “TCP” (Transmission Control Protocol) for exchanging data between the terminal and distribution server and receiving of stream data then starts. To access by using the stream control protocol RTSP, a session is first established by TCP and then receiving of data starts after acquiring stream information by utilizing RTSP.

The access control processor 14 establishes a session with distribution server by using the above described protocols. The address information for the distribution server and the group address information are stored in the multicast translation table 16 at the point in time that a session is established and receiving of data can start. When the group address information is already stored in the multicast translation table 16, data is being received from the distribution server so no access processing is performed.

The distribution data management section 15 performs processing to distribute to the user, the distribution program extracted as part of the information from the data management table 17. The data management table 17 can also be rewritten (updated) in the distribution data management section 15 by external operation for example by a network administrator.

The data transfer processor 18 checks whether the source address of the received data packet is stored in the multicast translation table 16. If the source address is stored there, then group address information corresponding to that source address is acquired from the multicast translation table 16. The data transfer processor 18 sets this acquired group address information in the destination address of the data packet that was received; sets the address of the source multicast distribution device 10 itself into the source address and sends it to the packet transmit section 19.

The packet transmit section 19 sends the data packet transferred by the data transfer processor 18 and control packet sent by the multicast protocol processor 13. The access control processor 14 sends the protocol packet used in communication with the distribution server and the (distribution) program conveyed by the distribution data management section 15.

FIG. 3 shows the structure of a packet 30 processed by the multicast distribution device 10.

The packet 30 is comprised of a header section 31 and a data section 32. The header section 31 contains a source address 33 for the packet 30, a destination address 34, and protocol information 35. The data section 32 contains a source port No. 36 and a destination port No. 37. This port No. is utilized as information for identifying individual stream data when multiple stream data have been distributed.

The destination address 34 is set in the distribution server address of the access request packet sent to the distribution server from the multicast distribution device 10. In the stream data packet sent from the distribution server to the multicast distribution device 10, the destination address is set in the multicast distribution device 10 address.

When the multicast distribution device 10 forwards the data packet received from the distribution server into the multicast network, the multicast distribution device 10 sets its own address in the source address 33 and sets the address of the multicast group into the destination address 34.

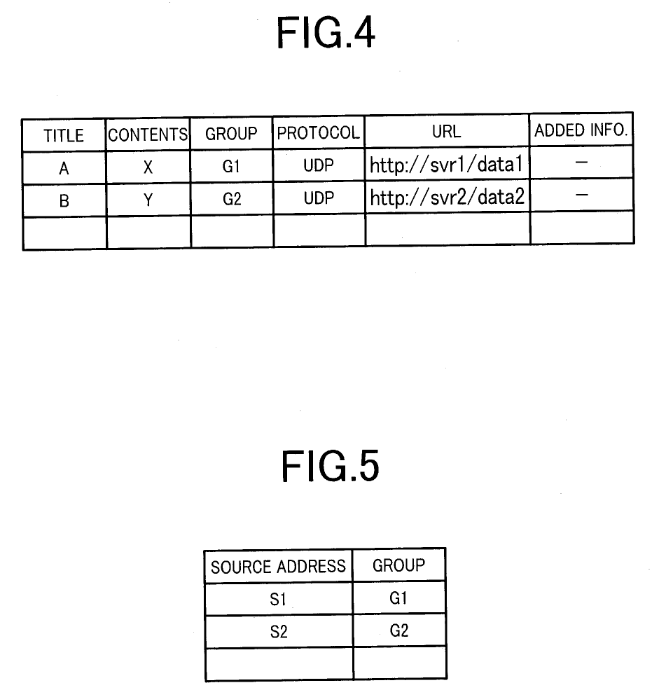

FIG. 4 shows the structure of the data management table 17 held in the multicast distribution device 10.

This data management table 17 is a table containing distribution data information and distribution data acquisition information. The stream data title, stream data content description, multicast group address of the distribution server and protocol names used in the distributing the stream data are stored within the distribution data information. Address information on the distribution server holding the stream data or access destination information are stored in URL format in the distribution data acquisition information.

Address or URL information can be set in the multicast group address and distribution server address information by multiple network protocols typified by IPv4 and IPv6. For example, when an IPv6 multicast group address was set in the group address, and address information for connecting to a network using IPv4 was set in the distribution server, then stream data can be received from the distribution server connected to the network using IPv4, and the stream data can be distributed in IPv6 multicast to the multicast network configured for IPv6.

Time information may also be included as information added to the distribution data information to be distributed. The multicast distribution device 10 uses the distribution time information for controlling access to the server. When the distribution time is set, the access control processor 14 does not access the distribution server outside of the (scheduled) distribution time even if a receive request has arrived. Data is therefore not sent at other than (scheduled) distribution times even if the distribution server is accessed so unnecessary packets do not flow through the network.

The distribution data management section 15 extracts distribution data information from the data management table 17 and sends it as the distribution program to a pre-established multicast group destination for delivery. A SDP (Session Description Protocol) specified in RFC2327 for example is used for notification of the distribution program. The contents set in the data management table 17 are not limited to the above items and may also contain information for distributing information specified in the SDP.

FIG. 5 shows an example of the multicast translation table 16.

The distribution server address of the data stream currently being received and group address information on the transmit destination of the data packet are stored in the multicast translation table 16.

The distribution server address is used to identify what stream data is being received from what server when the multicast distribution device 10 is receiving stream data from multiple distribution servers. The multicast translation table 16 in the data transfer processor 18 (FIG. 2) of the multicast distribution device 10 is searched based on the source address of the stream data packet received from the distribution server and transmit destination group address information matching the applicable address is acquired. The acquired group address information is set in the destination address of the received data packet and the multicast distribution device 10 address is set in the source address.

The protocol information and port No. information can be used to identify each stream data when receiving multiple stream data from the same distribution server. In those cases, protocol information and port No. information are stored beforehand in the multicast translation table 16 and the data management table 17. The data transfer processor 18 then searches the multicast translation table 16 based on the source address information, protocol information, and port No. information, and acquires the transmit destination group address information.

Information on the port No. used by the multicast packet is sometimes required in advance according to the multicast application. However the port No. used up until receiving the stream data from the distribution server is sometimes not known. In those cases, the administrator stores a predetermined port No. in the data management table 17 and informs the user with this information contained in the distribution program. When setting the group address information in the destination address of the data packet received from the distribution server, the data transfer processor 18 also sets the port No. as the port No. stored in the data management table 17 and sends it.

The operation of the terminal 51 receiving the distribution program, and selecting and receiving the stream data from the distribution program in the above multicast distribution system is described next.

When the terminal 51a is to receive streaming data from Title “A”, first of all, a group join request is sent to the distributor group address G1 of Title “A”.

When the multicast router 40b receives this group join request, the multicast router 40b starts processing according to the multicast routing protocol and sends a distribution request in a data packet addressed to group G1 to the multicast router 40a.

When the multicast router 40a receives this distribution request, it sends the distribution request data packet addressed to group G1, to the multicast distribution device 10 according to the multicast routing protocol. When this distribution request is received, the multicast distribution device 10 extracts the group address G1 requested in the multicast control packet from the transmit request and searches for information corresponding to G1 by searching the data management table 17 (FIG. 4). Here, “http://svr1/data1/” is stored in the data management table 17 as URL information corresponding to group G1, so the multicast distribution device 10 establishes a session for receiving the data specified in “data1” from the distribution server 50a whose host name is “svr1”. The group “G1” and the distribution server 50a address “S1” are stored at this time in the multicast translation table 16.

When the multicast distribution device 10 receives the stream data from the distribution server 50a, it respectively sets the destination address of the received data packet into “G1” and the source address into address “M2” of multicast distribution device 10 and transmits the data to the multicast router 40a. After receiving the data addressed to group G1, the multicast router 40a forwards the received packet data to the multicast router 40b that requested distribution of the data packet addressed to group G1. When the multicast router 40b receives the data packet addressed to group G1, it forwards the data packet to terminal 51a that sent the request for distribution of a data packet addressed to group G1.

When terminal 51b receives the stream data of Title “A”, the terminal 51b sends a group join request to the distributor multicast group G1 of title “A”. The multicast router 40b has already forwarded a data packet addressed to group G1 so when the group join request from terminal 51b is received, the stream data is forwarded to terminal 51b by processing according to the multicast routing protocol.

Further, when the terminal 51c is receiving Title “A” stream data, the terminal 51c sends a group join request to the distribution destination group G1 of Title “A”. When the multicast router 40c receives the group join request from the terminal 51c, it performs processing according to the multicast routing protocol and sends the distribution request data packet addressed to G1 to the multicast router 40a. The multicast router 40a has already forwarded a data packet addressed to group G1 to the multicast router 40b so the multicast router 40c forwards the data packet addressed to group G1 when the distribution request is received and forwards the stream data to the terminal 51c.

Next, when the terminal 50d receives the Title “B” stream data, the terminal 51d sends a group join request to distributor group G2 of Title “B”. The multicast router 40c performs the processing according to multicast routing protocol when the group join request is received and sends a distribution request in a packet data addressed to group G2 to the multicast router 40a. The multicast router 40a performs the multicast routing protocol processing when it receives this distribution request and sends the distribution request as packet data addressed to group G2.

When the multicast control packet for group G2 is received, the multicast distribution device 10 searches the information stored in the data management table 17, accesses the distribution server 50b of host name “svr2” matching group G2 by using the HTTP protocol, and requests distribution of the data shown in data2. When the multicast distribution device 10 receives data from the distribution server 50b, it respectively sets the data packet destination address in G2 and sets the source address in its own address M2, and sends the data to the multicast router 40a. The multicast router 40a and multicast router 40c that received the data, then forward the data packet addressed to G2, and send the stream data to the terminal 51d.

The procedure for stopping the receiving of data is described next.

The multicast distribution device 10 terminates the session with the distribution server at the point in time that there is no terminal to receive the distribution data and stops the receiving of data. In other words, when the terminals 51a, 51b, and 51c are respectively receiving data addressed to group G1, and the terminal 51a has received a group leave request from the group G1; the multicast router 40b processes the group leave request according to the multicast routing processing when it is received. The terminal 51b is still receiving data addressed to group G1 at this time so the multicast router 40b only forwards the group G1 data packets to the terminal 51b.

When the terminal 51b has received the group leave request from group G1, the multicast router 40b receives the group leave request. Multicast routing processing is performed and when then determined that there is no terminal to receive group G1 data, the multicast router 40b sends the stop data distribution stop request for group G1 to the multicast router 40a. When the multicast router 40a receives the stop data distribution request, it performs processing by multicast routing protocol so that the data packet for group G1 is forwarded only to the multicast router 40c.

When the terminal 50c has sent the group leave request from group G1, the multicast router 40c receives the group leave request and performs processing by multicast routing protocol. Since there is no terminal to receive the data packet addressed to G1, the multicast router 40c decides there is no need to forward it and sends a stop data distribution request to the multicast router 40a. The multicast router 40a receives the stop distribution request, processes it according to multicast routing protocol and after deciding there is no need to forward data to the multicast routers 40b, 40c, sends the stop distribution request for group G1 to the multicast distribution device 10. When the multicast distribution device 10 receives the stop distribution request from the multicast router 40a, it extracts the group address contained in the distribution stop request and stops access to the distribution server of that group address. The group address information and server address information is deleted from the multicast translation table 16 at this time. The process for stopping distribution of stream data is now complete.

The process flow when the terminal 51 is receiving data packets from the distribution server 50 is described next.

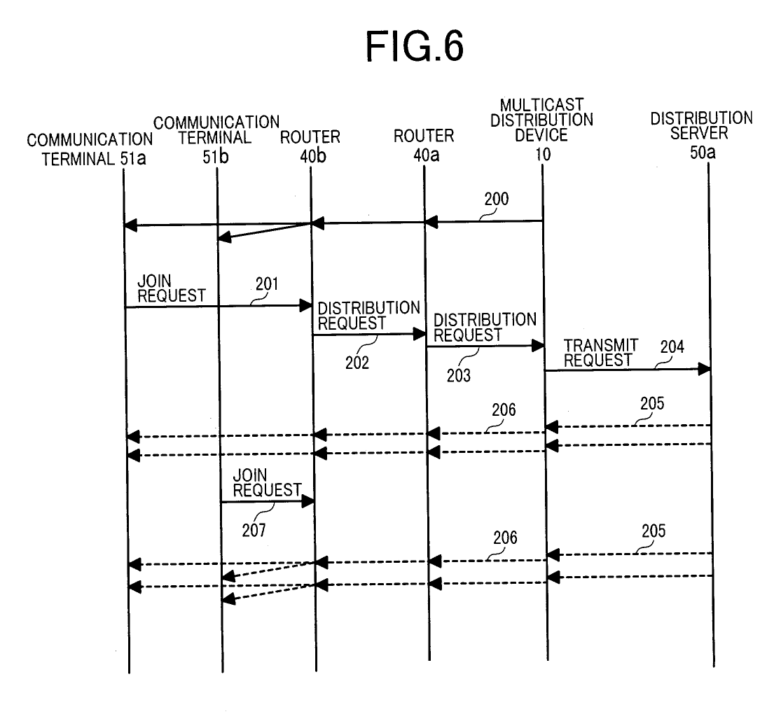

FIG. 6 is a diagram showing the sequence when the terminals 51a, 51b are receiving data packets from the distribution server 50a.

The multicast distribution device 10 periodically sends a distribution program 200 to the multicast network 70.

The terminal 51a receives the distribution program 200 and in order to receive desired stream data from the distribution program 200 first of all, sends a group join request 201 for group G1 which is the stream data group. When the multicast router 40b receives the group join request from the terminal 51a, it processes the request according to multicast routing protocol and sends a distribution request 202 for a data packet addressed to group G1 to the multicast router 40a. When the multicast router 40a receives this distribution request 202, it processes the request according to multicast routing protocol and sends a distribution request 203 for group G1-addressed data packet to the multicast distribution device 10.

When the multicast distribution device 10 receives this distribution request 203, it acquires information on the distribution server corresponding to group G1 and sends a transmit request 204 for data “data1” to the distribution server 51a. When the multicast distribution device 10 receives this transmit request 204 it establishes a session for sending stream data between the distribution server 50 and multicast distribution device 10. When this session is established, the distribution server 50 sends the stream data 205 in a unicast transmission to the multicast distribution device 10.

When the multicast distribution device 10 receives this stream data 205, it converts the destination address of the stream data 205 to ‘G1’ and forwards it to group G1 as multicast data 206. The multicast routers 40a, 40b forward the multicast data 206 and sent to the terminal 51a which made the distribution request to group G1.

When the terminal 51b sends a group join request 207 to group G1 in the same way, the multicast router 40b is already receiving multicast data 206 addressed to group G1 so when the multicast router 40b receives the group join request, it also forwards the multicast data 206 to the terminal 51b.

The processing for terminating the receiving of data packets being received by terminal 51 from the distribution server 50 or in other words the process flow quitting the group is described next.

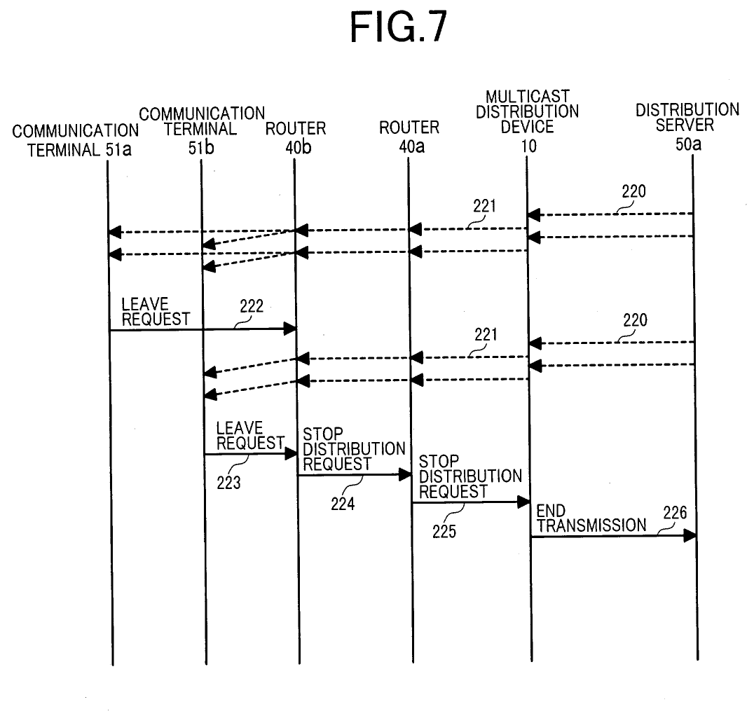

FIG. 7 shows the message sequence when the terminal 51b is quitting the group.

The multicast distribution device 10 converts the data packet 220 for group G1 from the distribution server 50a into a multicast data packet 221 and sends it. When the terminal 51a has sent the leave request 222 from the group G1, and the multicast router 40b receives the leave request 222, the request is processed according to multicast routing protocol and the forwarding of group G1 data packets to the terminal 51a is stopped. The forwarding of data to the terminal 51b continues at this time.

When the terminal 51b has sent the group leave request 223 from group G1, the multicast router 40b receives and processes the group leave request 223 according to multicast routing protocol, determines there is no terminal to receive the group G1 data packet, and sends a stop distribution request 224 for the data packet to the multicast router 40a.

The multicast router 40a receives the stop distribution request 224, processes it according to multicast routing protocol, and when multicast router 40a determines that forwarding of the group G1 data packet is not required, sends a stop distribution request 225 for the group G1 data packet to the multicast distribution device 10. When the muiticast distribution device 10 receives this stop distribution request 225, its sends a transmit termination packet 226 instructing that transmission of data to the server 50a be terminated. The distribution server stops distribution of the data packet when it receives the transmit termination packet 226.

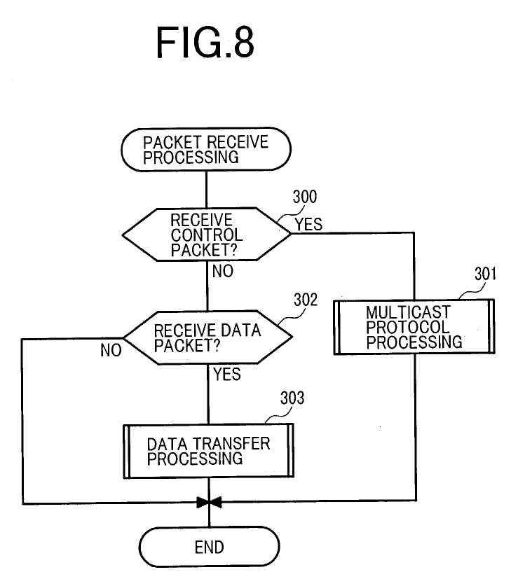

FIG. 8 is a flowchart showing the processing when the multicast distribution device 10 has received a packet.

The multicast distribution device 10 first of all identifies whether the received packet is a multicast control packet (step 300). This identification is made by using the protocol number (No.) of the received data packet. When a multicast control packet is received, multicast protocol processing (step 301) is performed. When found not be a multicast control packet in step S300, the packet is a data packet sent to the multicast distribution device 10 from a distribution server by unicast transmission and a decision made (step 302) as to whether the data packet should be forwarded in multicast. If the source address for the received data packet is stored in the multicast translation table, then data transfer processing is performed (step 303).

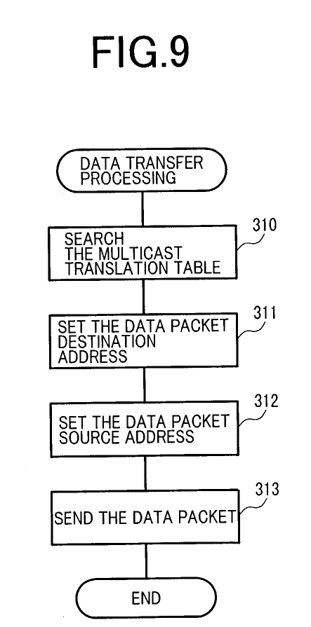

FIG. 9 is a flowchart showing the data transfer processing of FIG. 8 in detail.

A group address corresponding to the source address of the received data packet is first of all searched for and acquired from the multicast translation table 16 (step 310). The address of the multicast distribution device 10 itself is set in the data packet source address (step 311), the group address set in the destination address (step 312) and the address information converted. The data packet with converted address information is then transmitted (step 313).

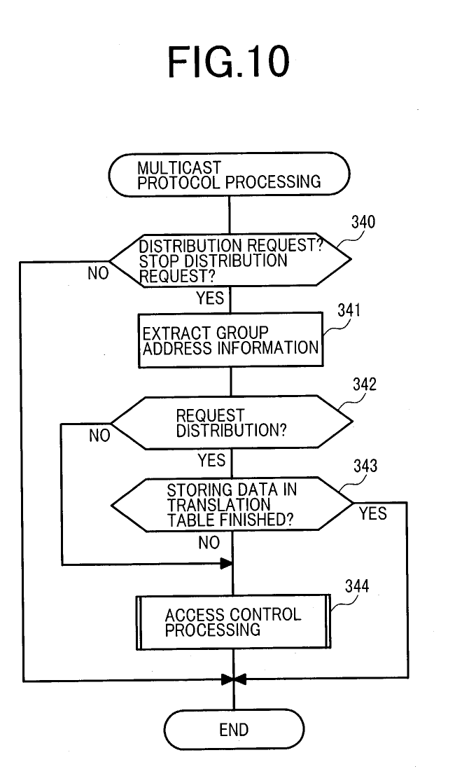

FIG. 10 is a flowchart showing the multicast protocol processing of FIG. 8 in detail.

A decision is first of all made (step 340) as to whether or not the received control packet is a packet showing a distribution request to a group or a stop distribution request. If a packet indicating a distribution request or a stop distribution request, then the requested group address information is extracted from the packet (step 341) and the processing ends when any other packets are received. A check is next made (step 342) as to whether the packet is a distribution request. If the packet is a distribution request, then a check is made whether the group address extracted from the packet is stored in the multicast translation table (step 343). If the group address is already stored there, then the processing ends. If the group address information is not stored there (multicast translation table) then access control processing is implemented (step 344) for starting data transmission from the distribution server for that group address information.

When determined in step 342 that the packet is a stop distribution request, access control processing is implemented (step 344) to stop receiving data transmission from the distribution server for that (corresponding) group address.

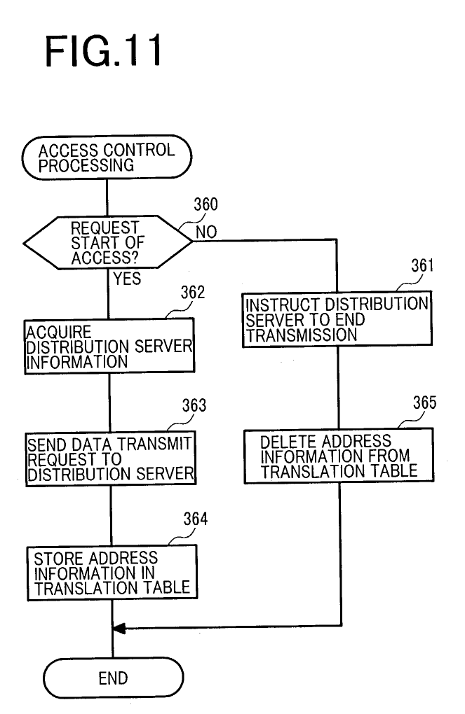

FIG. 11 is a flowchart showing the access control processing of FIG. 10 in detail.

A decision is first of all made (step 360) whether or not the request is distribution request (data transmit start request) to the distribution server or is a stop distribution request (data transmit stop request).

When the request is a transmission start request, the distribution server information corresponding to the group address reported from the data management table by the multicast protocol processing is extracted (step 362). An access request is then sent for acquiring distribution data in the distribution server based on the extracted server information and a session is established with the distribution server (step 363). After the session is established, the group address information and that server address information is stored in the multicast translation table (step 364).

When determined in step 360 that the request is a transmit stop request, a transmit stop request is sent to the distribution server, the session with the distribution server terminated (step 361), and the group address information and the distribution server address information is deleted from the multicast translation table (step 365)

In the multicast distribution system of the first embodiment configured as described above, when the client terminal 51 connected to the multicast network is receiving stream data from the distribution server 50 in the unicast network, the multicast distribution device 10 converts the unicast network data into multicast network data and distributes it to the client terminal 51 (that has joined the group) so that a data distribution service with a lower traffic flow in the network can be provided.

The second embodiment of the multicast distribution system of the present invention is described next.

The multicast distribution system of the second embodiment has a structure identical to that shown in FIG. 1 and FIG. 2 however it differs in having functions in the multicast distribution device 10 such as encrypting to prevent tampering, eavesdropping or unauthorized use of the distribution data.

The multicast distribution device 10 of the second embodiment is described next while referring to FIG. 2. A detailed explanation of structures whose operation is identical to the first embodiment is omitted.

The client terminal 51 sends a distribution program request packet to the multicast distribution device 10 when it wants to receive a distribution program.

A packet receiver 11 (FIG. 2) of the multicast distribution device 10 receives a distribution program request packet from the client terminal 51 the same as with other packets and sends it to the packet identifier 12.

When the packet identifier 12 determines that the packet is a distribution program request packet, a distribution program request packet is sent to the distribution data management section 15. When the distribution program request packet is received at the distribution data management section 15, authentication processing is first of all performed to verify whether or not the client terminal 51 requesting distribution of a program is a genuine user (or a contract user) allowed to receive the multicast distribution service. This authentication processing is implemented by communication of authentication information such as ID and passwords between the client terminal 51 and multicast distribution device 10 as needed. If the authentication process succeeds, the distribution program is encrypted in the distribution data management section 15 and sent to the client terminal 51 by way of the packet transmit section 19.

All communication for example for the distribution program request packet sent by the client terminal 51, and the authentication processing between the multicast distribution device 10 and client terminal 51 may be encrypted.

When the packet identifier 12 determines that received packet is a stream data packet, the packet is sent to the data transfer processor 18. When the packet identifier 12 determines that the packet is a control packet, it is sent to the multicast protocol processor 13. In the data transfer processor 18 and multicast protocol processor 13, processing is performed to report the group address information to the access control processor 14 the same as in the first embodiment. The access control processor 14 next accesses the distribution server 50 and establishes a session and encrypts communications such as for receiving data. The method for encrypting communication with the distribution server 50 is set in the data management table 17. In other words, information related to encrypting, for example, for the encrypting method in appended information of data management table and cryptographic keys are stored here. Also, information for decrypting the data encrypted for example by a public key is contained in the distribution program conveyed to the client terminal 51. Only the authorized client terminal 51 can decrypt the stream data by using this public key and receive the distribution information.

After a session is established with the distribution server, the distribution server address information and group address information are stored in the multicast translation table 16, the same as in the first embodiment.

The data management table 17 may also be configured to hold multiple information on stream data distributed to all users, and stream data only for authenticated users according to information in their contract. Stream data for distributions made to all users is conveyed in advance in a distribution program from the multicast distribution device 10 to the client terminal 51. A distribution program is conveyed to a contracting user only when there was a distribution program request so that special stream data will only be distributed to contracting users.

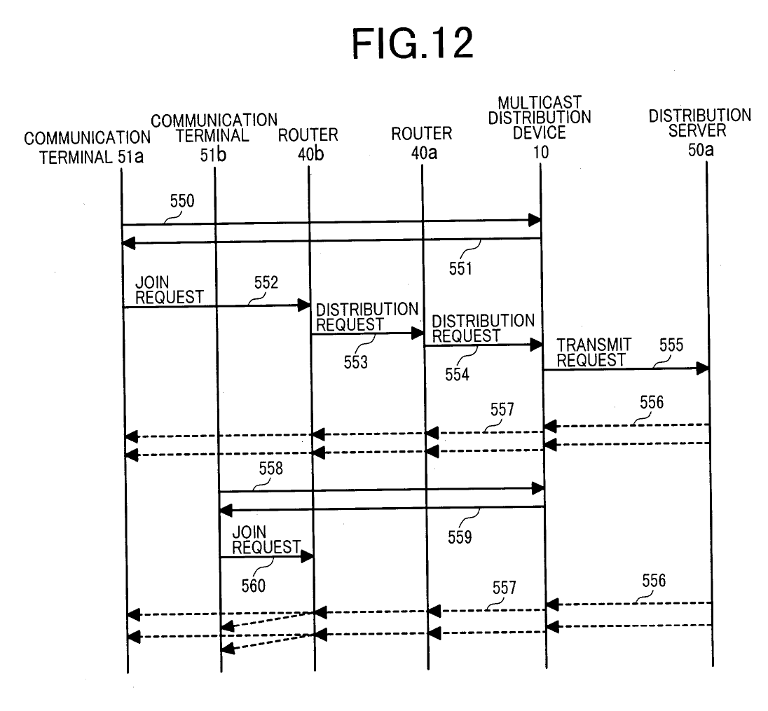

FIG. 12 shows the sequence when the terminal 51 is receiving data packets from the distribution server 50.

The terminal 51a first of all sends a distribution program request 550 to the multicast distribution device 10.

The multicast distribution device 10 authenticates the terminal user that sent the distribution program request 550. If authentication is successful and the user determined to be genuine, a distribution program 551 is sent to the terminal 51a.

The terminal 51a acquires the desired stream data information from the distribution program 551 and sends a group join request 552 to the applicable group G1.

When the multicast router 40b connected to terminal 51a receives the group join request 552 from the terminal 51a, it processes the request according to the multicast routing protocol and sends a distribution request 553 for a group G1 addressed data packet, to the multicast router 40a.

The multicast router 40a receives this distribution request 553 and sends it to the multicast distribution device 10. When the multicast distribution device 10 receives the distribution request 554, it acquires distribution server information for the corresponding group G1 from the data management table 17, and sends a transmit request 555 for data ‘data1’ to the distribution server 50a. When the distribution server 50a receives the transmit request 555, the stream data 556 is sent from distribution server 50a by unicast transmission to the multicast distribution device 10.

When the multicast distribution device 10 receives the stream data 556, it converts the destination address of the data packet to group G1 and sends it as the multicast data 557. This multicast data 557 is forwarded to the multicast routers 40a, 40b and distributed to the terminal 51a.

When the terminal 51 starts to receive the stream data at this point, a distribution program request 558 is first of all sent the same as for terminal 51. When the multicast distribution device 10 receives the distribution program request 558, user authentication processing of terminal 51b is performed and when successful, the distribution program 559 is conveyed to the terminal 51b. The terminal 51b acquires the desired stream data information from the distribution program 551 and sends a group join request 560 to the applicable group G1. When the multicast router 40b receives this group join request 560, the multicast data 557 addressed to group G1 is already being received so the multicast data 557 is also relayed to the terminal 51b.

The multicast data distribution system of the second embodiment requires data protection while distributing data. The VPN (Virtual Private Network) is used as a method for protecting data on the communication route between the multicast distribution device 10 and each distribution server.

The second embodiment as described above, encrypts and distributes stream data of distribution programs and stream data so that in addition to the effect of the first embodiment, a distribution service can be provided allowing only users on contract with the distribution service to receive distribution programs and further allowing only users on contract with the distribution service to search the distribution programs and view the stream data.

The multicast distribution system of the third embodiment of the present invention is described next.

In the multicast distribution system of the third embodiment, the multicast distribution device 90 has a multicast routing function. Sections with operation identical to the first and second embodiments are assigned the same reference numerals and a detailed description is omitted.

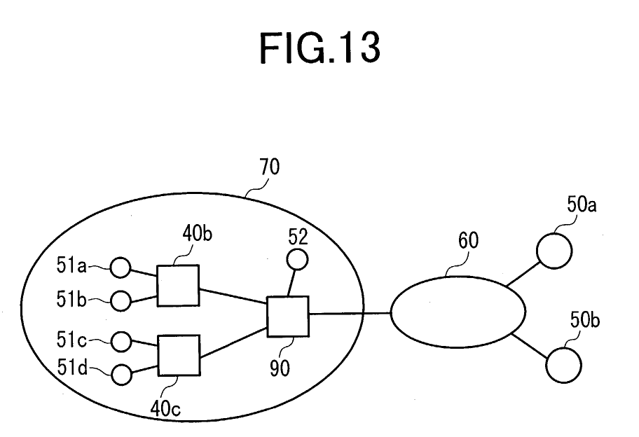

FIG. 13 is a diagram showing the multicast distribution system of the third embodiment.

The multicast distribution device 90 is installed within the multicast network 70 and connects to the multicast routers 40b and 40c. The multicast distribution device 90 further connects to the unicast network 60. The distribution servers 50a, 50b are connected to the unicast network 60. The terminal 51a and terminal 51b are connected to the multicast router 40a. The terminal 51c and terminal 50d are connected to the multicast router 40c. The multicast distribution device 90 is connected to the transmit terminal 52. This transmit terminal 52 is a terminal device for distributing in multicast, stream data for group G3 not stored in the data management table 17.

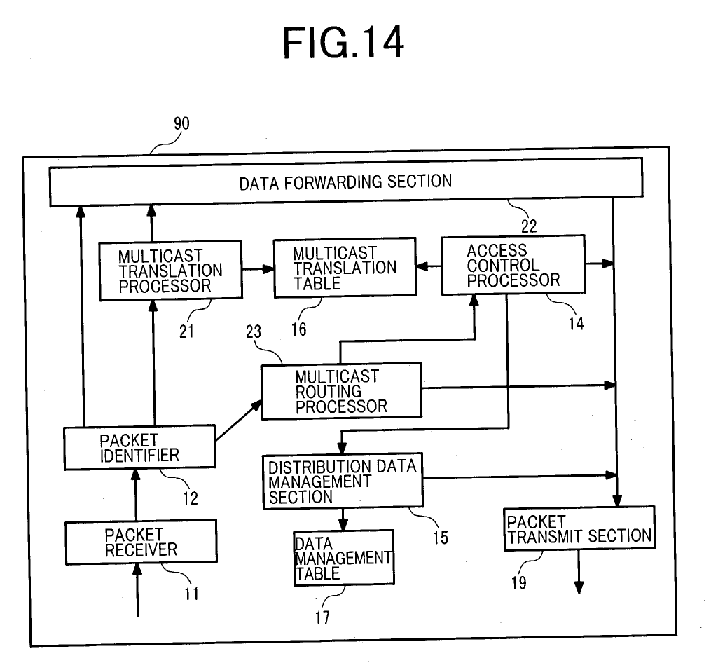

FIG. 14 is a block diagram showing in detail the multicast distribution device 90 of the third embodiment.

A packet receiver 11 receives multicast data packets, data packets sent in unicast format from the distribution server and control packets for multicast routing and sends them to the packet identifier.

When the received packet is a multicast control packet, the packet identifier 12 sends the received packet to the multicast routing processor 23. When a data packet is received that was transmitted in unicast from a distribution server, the packet identifier 12 sends that received packet to the multicast translation processor 21. When a multicast data packet is received, the packet identifier 12 sends that received packet to a data forwarding section 22.

The multicast routing processor 23 performs multicast routing according to the control packet that was received. If the control packet that was received is a control packet relating to a distribution request or stop distribution request then group address information contained in the received control packet is conveyed to the access control processor 14. Further, the group address information contained in the control packet is conveyed to the access control processor 14 even in cases where a group join request packet or a group leave request packet was directly received by the group management protocol.

The multicast translation processor 21 sets the group address in the destination address of the unicast data packet received from the distribution server based on the multicast translation table 16. In other words, address information of the multicast distribution device 90 itself is stored in the source address information and sent as a multicast data packet to the data forwarding section 22. The data forwarding section 22 forwards the multicast data packet received by the packet receiver 11 and the multicast data packet received from the multicast translation processor 21 according to multicast forwarding information.

The access control processor 14, distribution data management section 15, multicast translation table 16 and the data management table 17 are the same as in the first embodiment so a detailed explanation is omitted.

In the multicast distribution system configured as described above, the operation for the terminal 51 to receive the distribution program, and select and receive the stream data from the distribution program is described next.

First of all, the terminal 51a sends a group join request to the distribution group G1 of ‘A’ when it wants delivery (distribution) of Title ‘A’ stream data. The multicast router 40b starts processing according to the multicast routing protocol when it receives the group join request. The distribution request for a group G1 data packet is sent to the multicast distribution device 90.

When the multicast distribution request is received, the multicast distribution device 90 processes it according to multicast routing protocol, searches the data management table 17 for a group G1 data packet to forward to the multicast router 40b and acquires information on group G1, stores it in the multicast translation table 16, and sends the data for distribution to the distribution server 50a according to the contents stored in the data management table 17.

When the data distribution request is received, the distribution server 50a delivers (distributes) the data in unicast format to the multicast distribution device 90. The multicast distribution device 90 converts the received data packet into a group G1 multicast data packet and forwards it to the multicast router 40b. The multicast router 40b forwards the group G1 multicast data packet to the terminal 51a so that the terminal 51a can receive the stream data.

To receive the Title ‘A’ stream data, the terminal 51b here sends a group join request to group G1. The multicast router 40b has already relayed the group G1 multicast data packet to terminal 51a so this data packet is also forwarded to terminal 51b.

To also receive the Title ‘A’ stream data, the terminal 51c sends a group join request to group G1. When this group join request is received, the multicast router 40c processes it according to the multicast routing protocol and sends a group G1 data packet distribution request to the multicast distribution device 90. When this data packet distribution request is received, the multicast distribution device 90 processes this request according to the multicast routing protocol and forwards the group G1 data packet not only to the multicast router 40b but also the multicast router 40c. The multicast distribution device 90 is already accessing the distribution server for group G1 at this time so new access processing is not performed.

To receive the data distributed by group G3, the terminal 51d here sends the group join request to group G3. When the multicast router 40c receives this group join request, it sends a group G3 data packet distribution request to the multicast distribution device 90. When this multicast distribution device 90 receives this data packet distribution request, it processes the request according to multicast routing protocol, to forward the group G3 (addressed) data packet to the multicast router 40c. There is no information relating to group G3 stored in the data distribution table so accessing is not performed. The multicast distribution device 90 then forwards the group G3 (addressed) packet sent by terminal 52 to the multicast router 40c so that the terminal 51d can receive the stream data.

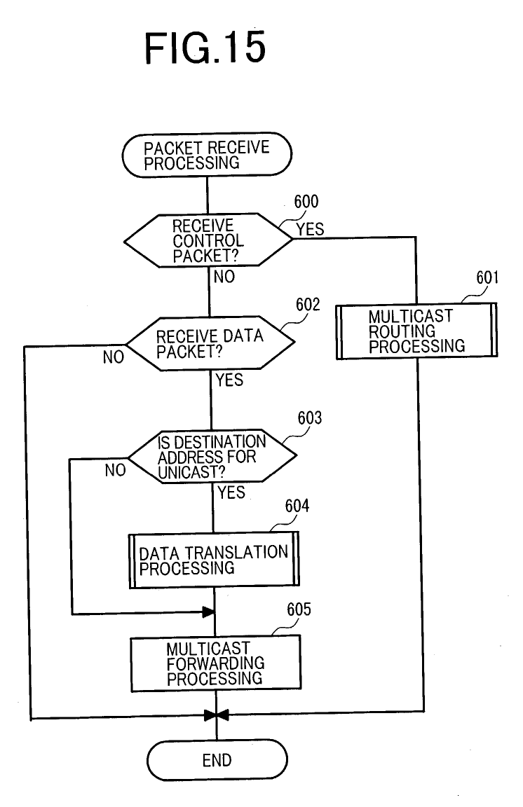

FIG. 15 is a flowchart showing the processing flow when the multicast distribution device 90 has received the packet.

The received packet is first of all identified as a data packet or as a control packet for multicast routing control (step 600). This identification can be made from the protocol No. of the received packet. When the received packet is a packet relating to multicast routing control, then multicast routing processing (step) 601 is implemented. When the received packet is not a packet relating to multicast routing control, a check is made to determine if it is a data packet needing forwarding (step 602). In other words, the data received by the multicast distribution device 90 is a data packet sent in a unicast format from the distribution server or is a data packet sent in multicast format from a transmit terminal. At that point if the destination address is multicast or the source address is stored in the multicast translation table (FIG. 5), then step 603 is implemented, and in all other cases the processing ends. Next, a decision is made as to whether the destination address is unicast or not (step 603). When the destination address is unicast, then this is a data packet sent from the distribution server so data translation processing (step 604) is implemented to convert the data to multicast, and multicast forwarding processing performed (step 605). If the destination address in step 603 is multicast, then data translation processing (step 604) is not performed and multicast forwarding processing is performed (step 605).

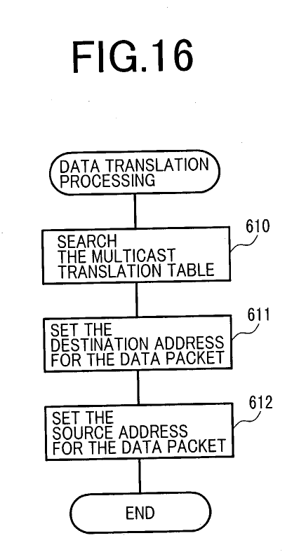

FIG. 16 is a flowchart showing in detail the data translation processing (step 604) of FIG. 15.

The group address corresponding to the source address of the received data packet is first of all searched for and acquired (step 610) from the multicast translation table (FIG. 5). Next, the group address is set in the data packet destination address (step 611), and the address of the multicast distribution device 90 is set in the data packet source address (step 612).

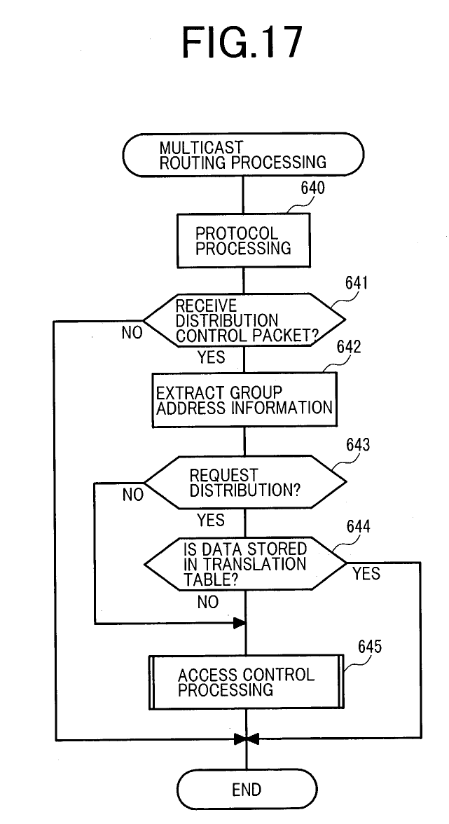

FIG. 17 is a flowchart showing in detail the multicast routing processing (step 601) of FIG. 15.

Protocol processing is first of all implemented according to the received protocol (step 640). A decision is next made if the received control packet is a distribution control packet (distribution request or stop distribution request) with instructions for controlling delivery to the group (step 641). If a distribution control packet then the group address requested by the packet is extracted (step 642). If a packet other than a distribution control packet then the processing is terminated.

A decision is next made whether the control packet is a distribution request or not (step 643). If the control packet is a distribution request, then a decision is made whether the extracted group address is stored in the multicast translation table or not (step 644). If the group address is already stored in the multicast translation table then the processing is terminated. However, if not stored, then access control processing is initiated (step 645) to start transmitting data from a distribution server for (matching) that group address information. This access control processing is the same the processing shown in FIG. 11 so an explanation is omitted.

The third embodiment of the invention configured as described above is therefore capable of reducing the number of distribution devices installed on the multicast network and reducing the management burden on the network administrator as well as the cost of distribution equipment when providing a multicast distribution services.

The multicast distribution system of the fourth embodiment of the present invention is described next.

In the fourth embodiment, processing for accessing the distribution server and processing for converting distributed data packets to multicast and forwarding them are implemented on separate devices. Sections that operate identical to the first and third embodiments are assigned the same reference numerals and their description is omitted.

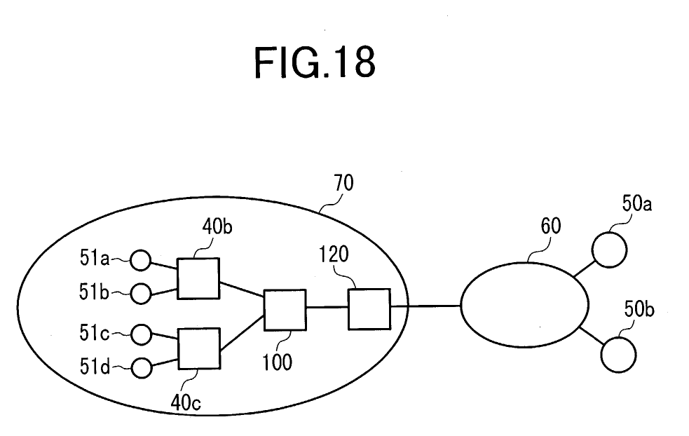

FIG. 18 is a block diagram showing the structure of the multicast distribution system of the fourth embodiment.

In a multicast distribution device 100, the multicast routers 40b, 40c and data management device 120 are connected to a multicast network 70. This data management device 12 is also connected to a unicast network 60.

The distribution servers 50a, 50b are connected to the unicast network 60. The terminals 51a, 51b are connected to the multicast router 40b. The terminals 51c, 51d are connected to the multicast router 40c.

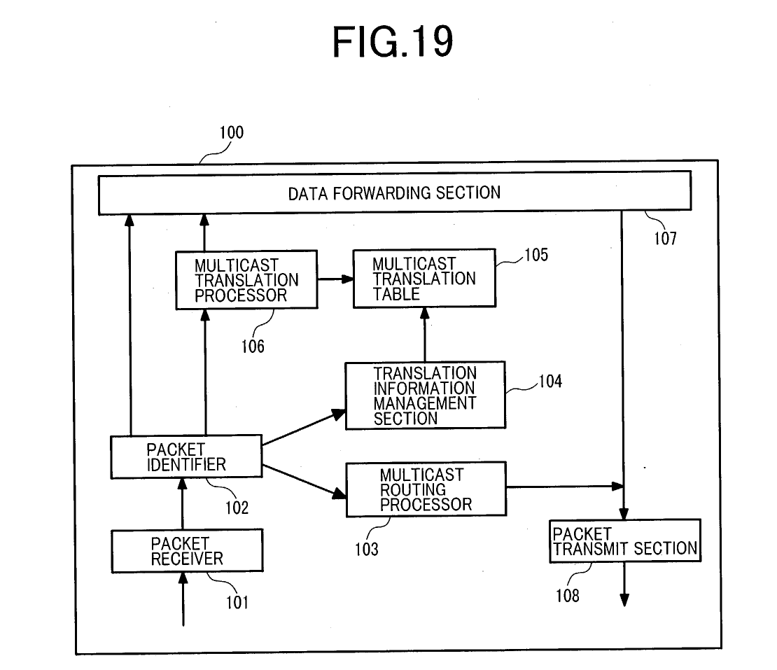

FIG. 19 shows a block diagram of the multicast distribution device 100. In this embodiment, the multicast distribution device 100 possesses a multicast routing control function.

A packet receiver 101 receives a multicast control packet, a unicast data packet sent from the distribution server by way of a data management device 120, multicast translation information conveyed from the data management device 120 and a multicast data packet for providing multicast routing functions and sends them to the packet identifier 102. The packet identifier 102 checks the received packet or information and when decided that the packet is a multicast control packet, sends it to the multicast routing processor 103.

The multicast routing processor 103 performs control processing indicated by the packet according to the multicast routing protocol. When the received packet is a control packet specifying a data packet distribution request or stop distribution request, then the group address information is extracted from the control packet, and the group address information conveyed to the data management device 120. When the received packet is a data packet from the distribution server, it is sent to the multicast translation processor 106. The multicast translation processor 106 converts the multicast data packet and sends it to the data forwarding section 107 the same as in the third embodiment. When the information identified in the packet identifier 102 is multicast conversion (translation) information then it is sent to translation information management section 104. The translation information management section 104, receives the multicast conversion information conveyed by the data management device 120 and performs updating (or rewriting) of the multicast translation table 105. The multicast conversion information includes address information on the distribution server for storage or deletion, and group address information, etc. When the packet identified by the packet identifier 102 is a multicast data packet, it is sent to the data forwarding section 107. The data forwarding section 107 performs forwarding processing of the received multicast data packet and the multicast data packet translated (converted) in the multicast translation processor 106.

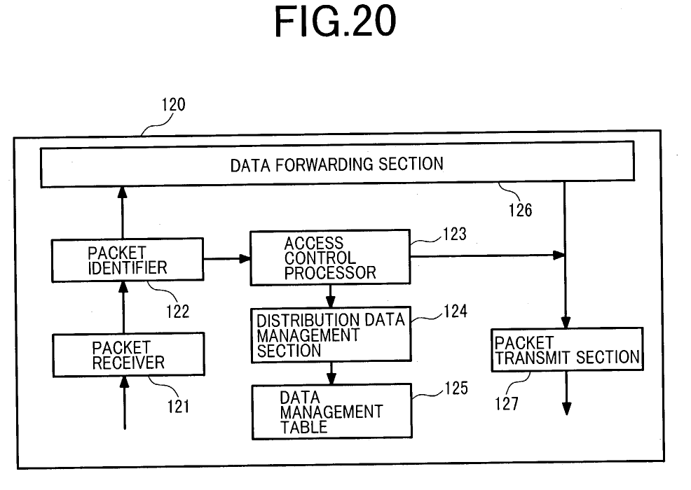

FIG. 20 is a block diagram showing the data management device 120.

The packet receiver 121 receives the group address information from the multicast distribution device 100, the data packet from the distribution server, and the distribution program request from the user, and sends them to the packet identifier 122. The packet identifier 122 identifies the received packet or information. When the received information is group address information the received packet is sent to the access control processor 123. The access control processor 123 accesses the distribution server, and when a session is established with the distribution server, converts the source address information and the group address information to multicast conversion (translation) information and conveys it to the multicast distribution device 100. After establishing the session with the distribution server, the data packet is sent from the distribution server to the multicast distribution device 100 without making any changes. When a packet from a user is received requesting a distribution program, the user is authenticated the same as in the second embodiment and the distribution program is sent only when the user is identified as a genuine user.

The operation in the multicast distribution system configured as described above for the terminal 51a to receive a distribution program and select stream data from the distribution program is described.

When the terminal 51a sends a group join request for a group having the desired data, the multicast router 40b receives the group join request and conveys the distribution request for a group-addressed data packet to the multicast distribution device 100 by multicast routing protocol processing. When the distribution request is received the multicast distribution device 100 processes it according to multicast routing protocol and conveys the group information requested for distribution to the data management device 120. When this group information is received, the data management device 120 makes a request for data distribution to the distribution server 50 according to the contents stored in the data management table 125, and conveys conversion (translation) information such as the distribution server address to the multicast distribution device 100.

When the data is distributed in unicast from the distribution server, the data management device 120 forwards it unchanged to the multicast distribution device 100. The multicast distribution 100 converts the data packet to a multicast data packet addressed to the group, based on the conversion information conveyed from the data management device 120 and forwards it to the multicast router 40b. The multicast router 40b forwards the multicast data packet to the terminal 51a.

When the terminal 51b has at this time received the group join request for the same group as the group requested by terminal 51a, the multicast router 40b receives the group join request and processes it according to multicast routing protocol. The multicast router 40b is already forwarding the group-addressed data packet to the terminal 51a so the data packet is also forwarded to the terminal 51b.

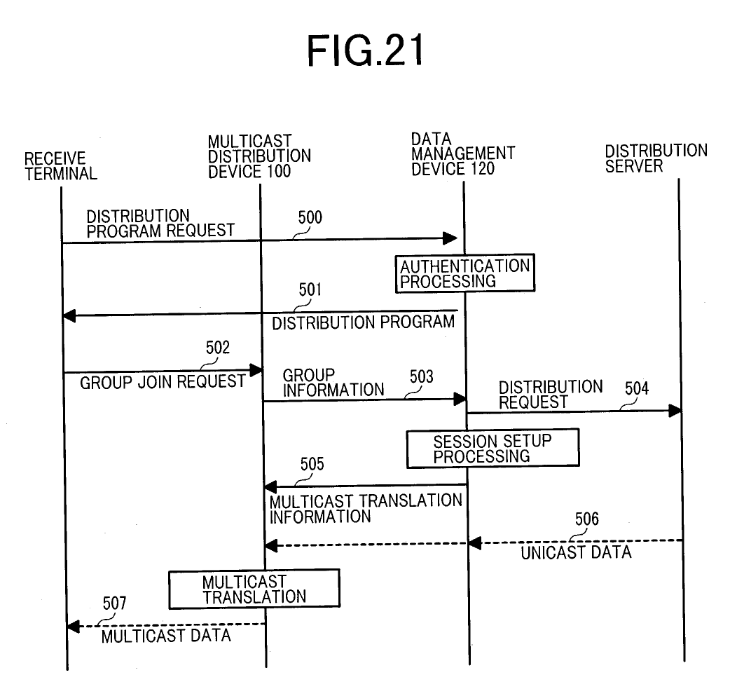

FIG. 21 is a sequence diagram of the process for the terminal 51 receiving data from the distribution server 50 by way of the multicast distribution device 100 and data management device 120.

The terminal 51 makes a request to the data management device 120 for a distribution program, and the data management device 120 authenticates the user.

The terminal 51 sends the distribution program request 500 to the data management device 120. When the distribution program request 500 is received, the data management device 120 first of all performs user authentication and if a genuine user, sends a distribution program 501. The distribution program request 500 and distribution program 501 may be encrypted and sent.

Next, the terminal 51 sends a group join request 502 for joining the group receiving the desired stream data by means of the distribution program. When the multicast distribution device 100 receives the group join request 502, it conveys the contents of the requested group information as group information 503 to the data managemetn device 120. When the group information 503 is received, the data management device 120 sends a distribution request 504 to the distribution server holding the stream data corresponding to that group information and requests distribution of data.

The data management device 120 next establishes a session for receiving data between it (120) and the distribution server. When the session is established, the multicast translation information 505 is conveyed to the multicast distribution device 100. This multicast translation information includes the same information as the multicast translation table shown in FIG. 4.

After establishing the session, a unicast data packet 506 is sent from the distribution server to the data management device 120 that requested the data distribution. The data management device 120 forwards the data packet 506 to the multicast distribution device 100. The multicast distribution device 100 converts the unicast data packet 506 to a multicast data packet 507 based on the received multicast conversion information and sends it to the terminal 51 so that stream data is distributed to the terminal 51.

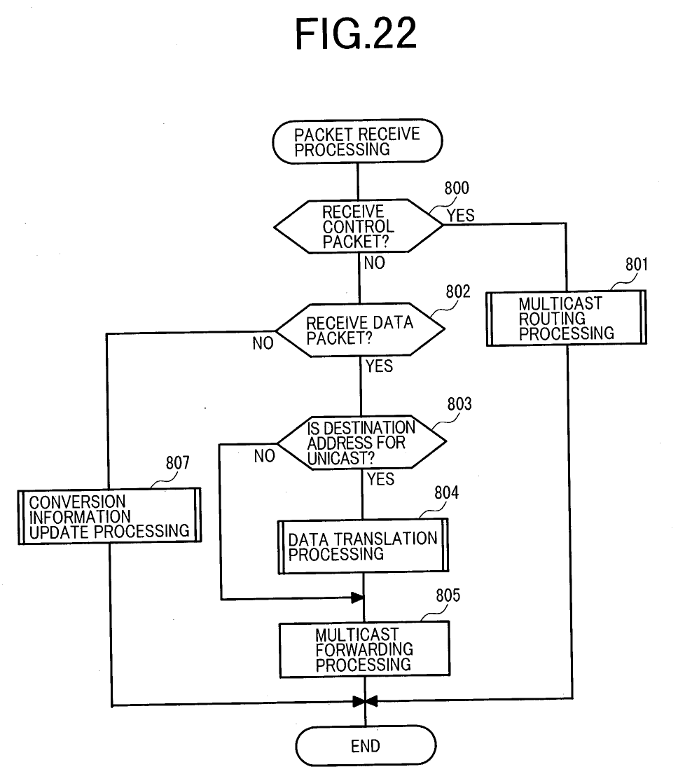

FIG. 22 is a flowchart showing the operation when a packet is received in the multicast distribution device of the present embodiment.

A decision is first made if the received packet is a control packet for multicast routing control or is another type of packet (step 800). This decision can be made by using the protocol No. of the received packet. If determined to be a multicast routing packet then multicast routing processing is implemented (step 801). If not a multicast routing packet then a decision is made whether it is a data packet requiring forwarding or notification of multicast conversion information from the data management device 120 (step 802). If the destination address is multicast or the source address is stored in the multicast translation table then it is determined to be a data packet requiring forwarding and step 803 is implemented. In step 803, if the destination address is unicast then the data sent from the distribution server is a data packet so after implementing data translation processing (step 804), multicast forwarding is implemented (step 805). This data conversion (or translation) is the same as the data conversion processing (FIG. 16) of the third embodiment.

If the destination address is multicast in step 803, then no data translation is performed (step 804) and multicast forwarding is implemented (step 805).

When a packet other than a data packet was received in step 802, then conversion information update processing (step 807) is performed.

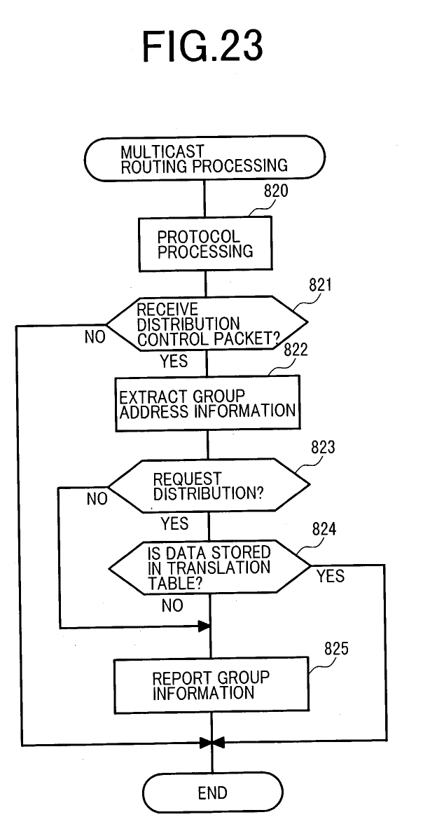

FIG. 23 is a flowchart showing in detail the multicast routing processing 801 of FIG. 22.

First of all, protocol processing is implemented accorded to the received protocol (step 820).

A decision is next made (step 821) whether the received control packet is a control packet specifying distribution to a group (distribution request or stop distribution request) or not. If the received packet is a control packet then the group address information requested by the control packet is extracted (step 822) and the processing of any other type of packet is terminated.

A decision is next made (step 823) whether the control packet is a distribution request or not. If a distribution request, a check is made whether the extracted group address is stored in the multicast conversion table (step 824). If the group address is already stored in the table then the processing ends. However, if not stored in the table then information showing the group address information and request are conveyed (reported) to the data management device 120 (step 825).

When the packet in step 823 is not a distribution request, then information showing the group address information and request are conveyed (reported) to the data management device 120 (step 825).

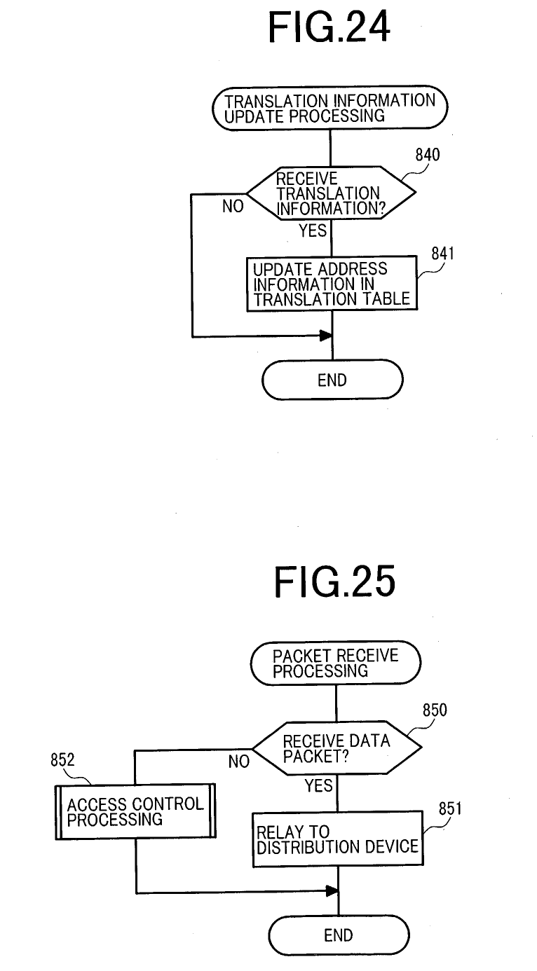

FIG. 24 is a flowchart showing in detail the conversion information update processing 807 of FIG. 22.

A decision is first of all made whether or not the received packet is a multicast translation information packet conveyed from the data management device 120 (step 840). If not a multicast translation information packet then the processing is terminated. If multicast translation information then it contains information showing address information on the distribution server, group address information and information showing distribution start or distribution stop. So if the multicast translation information contains information showing that distribution has started, then the distribution server address and group address information are stored in the translation table. When it contains information showing that distribution has ended, then the distribution server address and group address information are deleted from the translation table (step 841).

FIG. 25 is a flowchart showing the processing during receiving of the packet by the data management device 120. The data management device 120 receives any of the group address information from the multicast distribution device 100, data packets from the distribution server or distribution program request packets from the user.

A decision is first of all made if the received packet is a data packet sent from the distribution server or is another type of packet (step 850). If a data packet, it is forwarded unchanged to the multicast distribution device 100 (step 851). If not a data packet, then access control processing is implemented (step 851).

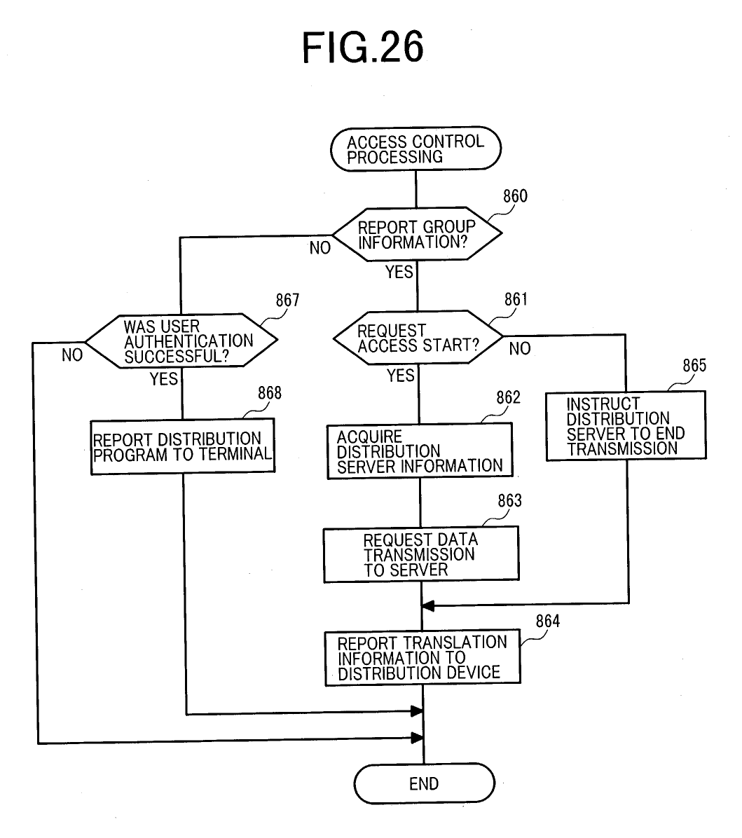

FIG. 26 is a flowchart showing in detail the conversion information update processing 852 of FIG. 25.

A decision is first of all made if the received information is group information notification from the multicast distribution device 100 or a distribution program from the user (step 860). If group information notification, then the notification information is determined to be a data transmit start request or a transmit stop request (step 861). When a transmit start request, the distribution information corresponding to the notified group information is extracted from the data management table (step 862). Based on this extracted group information, a data distribution request for acquiring distribution data is sent to the distribution server and a session established (step 863). After establishing the session, information showing the group information, server address information and that a session was established and data transmission started is conveyed to the multicast distribution device 100 as conversion (translation) information (step 864). When a stop transmit request was made in step 861, a transmit stop request is sent to the distribution server, the session with the distribution server is cut off (step 865), and information showing that the group address information, distribution server information and data transmit was stopped is conveyed to the multicast distribution device 100 as conversion (translation) information (step 864).

When not group information from the multicast distribution device 100, then this is a distribution program request from the terminal so user authentication is performed (step 867). When user authentication has succeeded, then the distribution program is sent to the terminal (step 868). If the user authentication failed then the process is terminated.

The multicast distribution system of the fourth embodiment, disperses the multicast processing into multicast routing (control) and access control implemented on separate devices, and the processing load on each device can be lowered so that in addition to the effect of the multicast distribution system of the second embodiment, the processing speed of the overall system is improved.

The multicast distribution system of the fifth embodiment is described next.

In the fifth embodiment, a system provides multicast distribution service using the multicast distribution systems of the first through fourth embodiments.

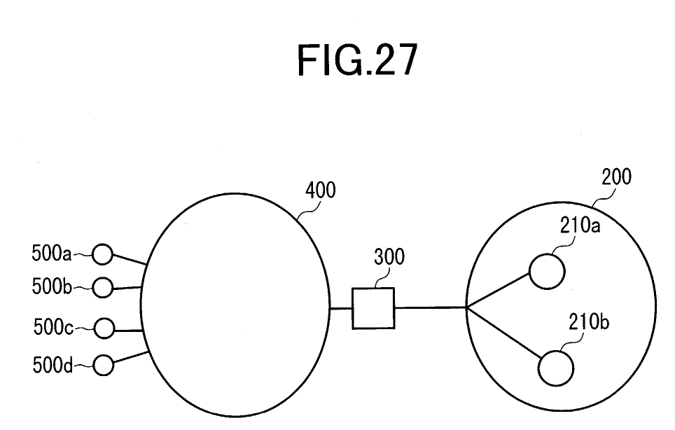

FIG. 27 is a block diagram of the system of the fifth embodiment.

A data provider 200 containing distribution servers 210 (210a, 210b) connects to a multicast distribution device 300 in unicast and distributes data for a fee. Here, ISP400 is a service provider connecting in multicast to the user terminals 500 (500a, 500b, 500c, 500d) and to the multicast distribution device 300.

In the multicast distribution system configured as described above, the service of the ISP400 for distributing billable data held by the data provider 200 is described.

The multicast distribution device 300 makes a request for data to the distribution server 210 of data provider 200 according to a request from the user terminal 500 connected to the ISP4000. The data is then acquired from the distribution server 210. In other words, the ISP400 makes a request for data on behalf of the user to the data provider 200.

When distributing data by conventional multicast, knowing the number of users currently receiving data is difficult. However in the present case, the ISP400 is the receiver of data from the data provider 200. The data provider 200 sets the billing fee (rate) assuming that the ISP400 distributes the data. To perform the billing, the multicast distribution device 300 may record information that logs the access with the distribution server 210.

The ISP400 pays a fee to the data provider 200 for the actual amount of data that was received. The user of the terminal 500 connected to the ISP400 is then billed according to a formula established by the ISP400.

In the multicast distribution system of the fifth embodiment as configured above, the data provider 200 provides data to the ISP400 by way of the multicast distribution device 300 for a fee (billing rate) In this way, billing can be performed for services provided between the data provider 200 and ISP400 or between the ISP400 and user (user terminal 500) and a system for providing data can easily be implemented.

What is claimed is:

1. A data distribution system for distributing multicast data sent from a transmit terminal connected to a second network incapable of multicast transmission, to multiple receive terminals connected to a first network capable of multicast transmission, wherein:
said system comprises a distribution device for distributing data sent from said transmit terminal to said multiple receive terminals;
said distribution device comprises:
information for said transmit terminal and, a linking information storage means for linking destination information for distributing data to said multiple receive terminals with said transmit terminal information;
a control packet receive means for receiving a control packet from said receive terminal requesting the distribution of data; and
a data transmit request means for searching said corresponding information based on said request for data distribution and requesting transmit of data to said transmit terminal.

2. A data distribution system according to claim 1, wherein said distribution device comprises a distribution means for changing a data packet sent from said transmit terminal into a data packet addressed to a destination contained in said data distribution request and distributing said data packet.

3. A data distribution system according to claim 1, wherein said distribution device comprises a linking information generation means to generate information corresponding to said transmit terminal and multicast information of said distribution based said data distribution request.

4. A data distribution system according to claim 1, wherein:
said distribution device comprises a data information distributing means for distributing to said receive terminal, data held by said transmit terminal utilizing data distribution information selected by said receive terminal, and
said receive terminal comprises a data distribution request means for selecting data held by said transmit terminal utilizing said data distribution information and requesting distribution of data.

5. A data distribution system according to claim 4, wherein:
said receive terminal comprises an authentication request means to request authentication relating to distribution of said data, and
said distribution device comprises:
an authentication request receive means to receive authentication requests from said receive terminal; and
an authentication means to authenticate said receive terminal, and
said data information distributing means distributes said data distribution information to terminals successfully authenticated by said authentication means.

6. A data distribution system according to claim 5, wherein:
said receive terminal comprises an encrypting means to encrypt said authentication request and an authentication request means for requesting authentication relating to distribution of said data, and
said distribution device comprises an encrypting means to encrypt said data distribution information; and
said data information distributing means distributes said encrypted data distribution information.

7. A data distribution system according to claims 1, wherein said distribution device comprises an encrypting means to encrypt data for distribution to said receive terminal.

8. A data distribution system according to claims 1, wherein said distribution device sends control packets according to multicast routing protocol utilized in the data request.

9. A data distribution system according to claims 1, wherein:
said distribution device comprises:
a management device for receiving data from said transmit terminal connected to a said second network, and having a linking information storage means and, said data transmit request means; and
a data distribution device for distributing said data to said receive terminal connected to said first network and having said data distribution request receive means.

10. A data distribution system according to claims 1, wherein the network protocol used by said first network and the network protocol used by said second network are different.

11. A data distribution device for distributing multicast data sent from a transmit terminal connected to a second network incapable of multicast transmission, to multiple receive terminals connected to a first network capable of multicast transmission, wherein:
said data distribution device comprises:
information for said transmit terminal and, a linking information storage means for linking destination information for distributing data to said multiple receive terminals with said transmit terminal information;
a control packet receive means for receiving a control packet from said receive terminal requesting the distribution of data; and
a data transmit request means for searching said corresponding information based on said request for data distribution and requesting transmit of data to said transmit terminal.

12. A data distribution device according to claim 11 comprising: a distribution means for changing a data packet sent from said transmit terminal into a data packet for a destination contained in said data distribution request and distributing said data packet.

13. A data distribution device according to claim 11, comprising: a linking information generation means to generate information corresponding to said transmit terminal and multicast information of said distribution based said data distribution request.

14. A data distribution device according to claims 11, comprising: a data information distributing means to distribute to said receive terminal, data held by said transmit terminal utilizing data distribution information selected by said receive terminal.

15. A data distribution device according to claim 14, comprising:
an authentication request receive means to receive authentication requests from said receive terminal; and
an authentication means to authenticate said receive terminal, and
said data information distributing means distributes said data distribution information to terminals successfully authenticated by said authentication means.

16. A data distribution device according to claim 15, comprising:
an encrypting means to encrypt said authentication request;
an authentication request receive means for receiving said authentication request encrypted by said receive terminal; and
an encrypting means for encrypting said data distribution information, and
said data information distributing means distributes said encrypted data distribution information.

17. A data distribution device according to claims 11, comprising: an encrypting means for encrypting data distributed to said receive terminal.

18. A data distribution device according to claims 11, for sending control packets according to a multicast routing protocol utilized in the data request.

19. A data distribution device according to claims 11, comprising:
a management device for receiving data from said transmit terminal connected to a said second network, and having a linking information storage means and, said data transmit request means; and
a data distribution device for distributing said data to said receive terminal connected to said first network and having said control packet receive means.

20. A data distribution device according to claims 11, wherein the network protocol used by said first network and the network protocol used by said second network are different.

21. A data communication method utilized in a data distribution system comprising a data distribution device for distributing data sent from a transmit terminal connected to a second network incapable of multicast transmission, to multiple receive terminals connected to a first network capable of multicast transmission and, distributing data sent from said transmit terminal in multicast to said multiple receive terminals, wherein:
said distribution device stores linking information for linking said transmit terminal information with destination information for distributing data to said multiple receive terminals, receives control packets requesting said data distribution from said receive terminal, and searches said corresponding information based on said request for data distribution and requests transmit of data to said transmit terminal.

22. A data communication method according to claim 21, wherein said distribution device changes a data packet sent from said transmit terminal into a data packet addressed to a destination contained in said data distribution request and distributes said data packet.

23. A data communication method according to claim 21, wherein said distribution device generates linking information to link the multicast information of said distribution with said transmit device based on said data distribution request.

24. A data communication method according to claims 21, wherein the network protocol used by said first network and the network protocol used by said second network are different.
